(19) United States
(12) Patent Application Publication
(10) Pub. No.: US 2018/0007927 A1
(43) Pub. Date: Jan. 11, 2018

(54) EASILY DIGESTIBLE CHOCOLATE PRODUCT

(71) Applicant: CAVALIER, Eeklo (BE)

(72) Inventor: Felix VERDEGEM, Eeklo (BE)

(21) Appl. No.: 15/537,828

(22) PCT Filed: Dec. 17, 2015
(86) PCT No.: PCT/EP2015/080307

§ 371 Date: Jun. 19, 2017

(30) Foreign Application Priority Data
Dec. 18, 2014 (EP) 14199004.4

(51) Int. Cl. A23G 1/40

(52) U.S. Cl. CPC A23G 1/40; A23L 27/33; A23L 27/31; A23V 2002/00

(57) ABSTRACT

The present invention concerns an easily digestible low sugar chocolate product for consumers with sensitivity to dietary carbohydrates such as lactose or fructans. In particular, the present invention concerns a composition for manufacturing a sweet tasting chocolate product that comprises less than 5%, or less than 2%, or even less than 1% poorly absorbable in the human small intestine fermentable oligo-, di-, monosaccharides, or related alcohols, collectively known as FODMAPs (Fermentable Oligo-, Di-, Monosaccharides And Polyols), wherein the sweet taste is provided by a sweetener selected from a group consisting of mogroside enriched monk fruit extract, isomaltulose, sweet tasting protein, or any combination of the above.

### TECHNICAL FIELD

The present invention concerns an easily digestible low sugar chocolate product for consumers with sensitivity to dietary carbohydrates such as lactose or fructans. In particular, the present invention concerns a composition for manufacturing a sweet tasting chocolate product that comprises less than 5%, or less than 2%, excor even less than 1% poorly absorbable in the human small intestine fermentable oligo-, di-, monosaccharides, or related alcohols, collectively known as FODMAPs (Fermentable Oligo-, Di-, Monosaccharides And Polyols), wherein the sweet taste is provided by a sweetener selected from the group consisting of mogroside enriched monk fruit extract (Siraitia grosvenorli), isomaltulose, sweet tasting protein, or any combination of the above.

### BACKGROUND OF THE INVENTION

Frequent consumption of sugar and high sugar foods is currently one of the major causes of obesity and a risk factor for pathologies associated therewith such as type 2 diabetes, cardiovascular diseases, various cancers, inflammation, and related metabolic conditions including impaired glucose tolerance, insulin sensitivity, dyslipidemia, elevated blood uric acid etc.

The above listed and more medical implications of sugar consumption are increasingly putting pressure on chocolate and confectionery manufacturers to reduce or even entirely substitute sucrose in their products.

However, effective implementation of the above imposes considerable formulation changes on regular chocolate, containing typically 40-60% sucrose which needs to be replaced. A number of sugar replacers is known and those permitted for use in foods include polyols, bulking agents and non-sugar intense sweeteners.

Polyols have a sweetness comparable to sucrose, but they are incompletely absorbed into the blood stream from the small intestine, resulting in a smaller increase in blood glucose which makes them safer for diabetics. Polyols include e.g. isomalt, lactitol, sorbitol, maltitol, xylitol and erythritol. The bulking agents are usually fermentable fibres composed of simple sugar chains including e.g. polydextrose, fructo-oligosaccharides (FOS), or inulin. They largely cannot be broken by human hydrolases so, human body on its own cannot metabolise them like normal carbohydrates. Lastly, intense sweeteners comprise a diverse group of chemical compounds many to hundreds of times sweeter than sucrose. They include e.g. stevia-derived glycosides, aspartame, sucralose, neotame, acesulfame potassium, thaumatin and saccharin.

As with all food products, the development of a formulation to replace sugar with an alternative sweetener is a complex process. In the particular case of chocolate, the final product is additionally expected to meet high standard expectations of the consumers with regard not only to sweetness but also to texture, mouthfeel, melt-in-the-mouth quality, creaminess, richness of taste and even such physical properties as snap or gloss. For these reasons, replacing sugar with an alternative sweetener often means the need to rework the entire composition for achieving the desired balance between sweetness and other properties of the final product.

Whereas polyols generally exhibit similar bulk properties compared to sucrose, and therefore could in theory substitute sucrose in volume-for-volume amounts, in practice however their sweetness is not sufficiently strong and thus they largely have to be provided in a mix with an intense sweetener. Intense sweeteners alone often have notably different mouthfeel and can have strong unpleasant aftertastes, so they usually have to be mixed with bulking agents for achieving the satisfactory texture sensation and also masking off-flavours.

The problem however with polyols and bulking agents is that, as recently shown, through fermentation by the human intestinal flora and their osmotic effects, they tend to cause abdominal pain, bloating, flatus-passing, diarrhoea, and generally altered bowel function and gastric distress leading to general discomfort (Barrett et al. 2010; Ong et al. 2010). Poorly absorbed short chain carbohydrates and sugar alcohols having such detrimental properties are collectively known as FODMAPs, or fermentable oligo-, di-, monosaccharides and polyols (Gibson and Shepherd, 2005; Shepherd and Gibson, 2006). The most commonly used FODMAPs in the food industry are e.g. fructans, fructose, galacto-oligosaccharides (GOS), and sugar polyols. Certain individuals experience the above listed discomfort symptoms even in a single-serving dose and the symptom intensity becomes seriously exacerbated in individuals affected by functional gastrointestinal disorders (FGIDs) such as Irritable Bowel Syndrome (IBS), or functional dyspepsia. In fact, recent research (Biesiekierski et al., 2013) has even suggested that FODMAPs and not gluten are the main culprit behind a fairly-common condition currently known as non-coeliac gluten sensitivity (NCGS), which unlike coeliac disease (which is an autoimmune condition triggered by gluten proteins) used to be considered as an innate immune response to gluten, resulting in gastrointestinal distress and inflammation.

Another FODMAP commonly occurring in chocolate is lactose—the sugar derived from milk solids which must legally be present in white and milk chocolate. For example, the legal minimum for milk solids in US is 14% with most formulations well in excess of this. The minimal 14% whole milk solids may provide up to about 7 g lactose per 100 g milk chocolate, which is enough to cause gastrointestinal distress in lactose sensitive subjects.

The object of the present invention is thus to provide a low sugar sweet tasting composition for a chocolate product of easy digestibility for FODMAP sensitive individuals, wherein the FODMAP content does not exceed 5%, or 2%, or even 1% w/w and wherein a non-FODMAP sweetener is provided, i.e. a sweetener selected from the group comprising monk fruit extract (Siraitia grosvenorli), isomaltulose, sweet tasting protein, or any combination of the above. The present invention concerns compositions for low sugar easily digestible chocolate products such as chocolate bars, confectionery fillings therefor, chocolate spreads, drinking chocolate powders, or chocolate beverages, and alike that would be suitable for calorie restricting consumers, ones suffering from obesity or diabetes, and further affected with sensitivity to lactose, polyol sweeteners, or poorly absorbable short chain carbohydrates present in other artificial sweeteners and bulking agents. The present invention also provides compositions for manufacturing a sugar free chocolate product, wherein not more than 5%, or not more than 2%, or even not more than 1% w/w FODMAPs is present and not more than 5%, or not more than 2%, or even not more than 1% w/w sucrose or glucose is present, and wherein said product comprises a sweetener selected from the group comprising monk fruit extract, isomaltulose, sweet tasting protein, or any combination of the above, and may further comprise water insoluble non-fermentable fibre such as cellulose, sterculia, or methylcelullose, or slowly fermentable fibre such as lignin.

Reduction of sugars and lactose may lead to contents of alternative sweeteners in excess of 60%. Such large additions of sweeteners worsens the know problems in chocolate manufacture, among others, increased viscosity during production and deterioration of texture, mouthfeel and flavour. However, prior art provides examples of dietary chocolate compositions with alternative sweeteners.

One example includes WO2007059644 disclosing regular chocolate compositions wherein at least 30% w/w sucrose is replaced by a combination of fermentable short chain carbohydrate bulking agents including dextrins, inulin and FOS. Another example is WO2006015880 wherein sugar replacement comprises inulin, polydextrose, and/or polysaccharide resistant maltodextrin as a bulking fibre and a high intensity sweetener. A low cariogenic chocolate composition wherein more than 1% fermentable non-milk sugar and substantial amount of lactose are replaced in the final product with polyols (even up to 65%) and bulking agents is provided in WO1995004469. Further chocolate related examples include EP0512910 and EP0317917, both applications suggesting polydextrose as sugar replacement.

As can be appreciated from these and other prior art documents, sugar replacement or elimination in chocolate compositions has traditionally been tackled with polyols and fermentable poorly absorbable short chain carbohydrates that form part of the FODMAP compounds. As the latter are implicated in gastrointestinal distress and complications in many individuals, it has been the goal of the present invention to provide sweet and easily digestible chocolate product compositions without the use of sugars or FODMAPs while still preserving the product workability and the properties desired by consumers such as texture, melt-in-the-mouth quality and richness of taste.

### SUMMARY OF THE INVENTION

The present invention is defined in the appended independent claims. Preferred embodiments are defined in the dependent claims. In particular, the present invention concerns a composition for manufacturing a chocolate product, comprising a non-sucrose non-glucose sweetener and at least 20% w/w fat, wherein
not more than 5%, or not more than 2%, or even not more than 1% w/w fermentable oligo-, di-, monosaccharides and polyols (FODMAPs) is present, and
wherein said non-sucrose non-glucose sweetener is selected from the group comprising:
   a. mogroside enriched monk fruit extract (Siraitia grosvenorli);
   b. isomaltulose;
   c. sweet tasting protein;
   d. any combination of the above listed sweeteners.

In a preferred embodiment, the composition of the present invention comprises 0.1%-10% w/w of the mogroside enriched monk fruit extract content or the sweet tasting protein content, and/or between 1% and 50% w/w isomaltulose.

In specific embodiments according to the previous embodiments, the sweet tasting protein is selected from the group comprising thaumatin, monellin, mabinlin, pentadin, brazzein, curculin, miraculin, with preferably thaumatin.

In further advantageous embodiments of the present invention, the composition may comprise further additions, such as fibre sources, milk protein, cocoa powder or liquor, various flavouring extracts, water regulating compounds etc. for as long as their composition is restricted not to exceed the maximum of 5%, or 2%, or even 1% FODMAP content in the final product.

For example, in a preferred embodiment the composition according to the present invention further comprises fibre source selected from any of the following
a. insoluble non-fermentable fibre, such as cellulose, sterculia, or methylcelullose;
b. insoluble slowly fermentable fibre such as lignin;
c. nuts selected from the group comprising whole nuts, chopped nuts, grounded nut powder, or a peeled or chopped counterpart thereof;
d. any combination of the above listed fibre sources.

In further aspects, particularly suitable for manufacturing of a milk or white chocolate product, the composition according to the present invention may further comprise protein source for mimicking milk protein component, which is a protein source comprising not more than 5%, or not more than 2%, or even not more than 1% w/w lactose and not more than 5%, or not more than 2%, or even not more than 1% w/w other FODMAP preferably selected from
a. milk protein extract or isolate;
b. casein/whey mixtures;
c. soyprotein;
d. any combination of the above listed protein sources.

In another aspect the present invention teaches manufacture methods of chocolate products comprising the step of preparing any of the compositions according to the present invention and preparing a chocolate product comprising any of the said compositions.

In final aspect, the present invention provides the use of a composition according to the invention to manufacture a chocolate product, wherein said product is preferably selected from
a. solid chocolate product such as bar or tablet;
b. filling for a chocolate product;
c. chocolate spread;
d. chocolate beverage;
e. chocolate powder.

### Definitions

The term “chocolate product” (or “chocolate”) as used herein refers to any confectionery made from at least z % w/w roasted ground cacao seeds, usually sweetened and flavoured. As used herein, the term “chocolate product” should be understood as referring to any type of chocolate mass (milk, dark, or white), chocolate coating, chocolate filling, soft chocolate chunks, chocolate spread and so on for use in any desirable applications (confectionary, bakery, chilled or frozen desserts such as ice cream, etc.). Dark chocolate products typically comprise a mixture of cocoa liquor, cocoa powder, cocoa butter, cocoa butter equivalents and/or cocoa butter substitutes, sugar and/or sugar substitutes, and one or more emulsifiers. They may also include milk fat. Milk chocolate products also comprise milk fat together with milk solids (such as milk powder). White chocolate does not include cocoa liquor or cocoa powder but, like milk chocolate, includes milk fats and milk solids. All chocolate products may include additional ingredients such as flavouring agents, colouring agents and/or texturizing agents. They may also comprise so-called inclusions such as nut products, fruit products, cereal products, etc. Certain chocolate products may also include water.

As use herein the term “FODMAP” shall be understood as any compound belonging to the group of Fermentable Oligo-, Di-, Monosaccharides And Polyols comprising short chain carbohydrates defined as oligo-, di-, monosaccharides and related alcohols that are poorly absorbed in the small intestine. These include short chain saccharide polymers of fructose (known as fructans) or galactose (galactans), disaccharides (lactose), monosaccharides (fructose), and sugar alcohols (polyols) such as sorbitol, mannitol, isomalt, xylitol, maltitol, erythritol, and lactitol. FODMAPs are naturally present in high amounts in honey, high fructose corn syrup or corn syrup solids, molasses or brown sugar, spelt, kamut, wheat flour in any form, hydrogenated starch hydrolysates (HSH), guar gum. Popular carbohydrate examples of FODMAPs include many bulking agents such as polydextrose, inulin, fructo-oligosaccharides (FOS), galacto-oligosaccharides (GOS) etc.

As used herein the term “monk fruit extract” or “mogroside enriched monk fruit extract” is to be understood as an extract of a sweet fruit Siraitia grosvenorli, also known as the monk fruit or luo/lo han guo/kuo, wherein said extract is to be understood as comprising an enriched fraction of triterpene glycosides called mogrosides and largely derived from FODMAP contamination. The pure mogroside mix extracted from the S. grosvenorli fruit is 300 times sweeter than sugar. Pure mogroside-5 can be up to 400 times as sweet. An example of mogroside purification procedure can e.g. be found in WO2012103074.

As used herein the term “isomaltulose” (6-O-α-D-glucopyranosyl-D-fructose) refers to a disaccharide naturally occurring in honey and sugar cane. It has similar sweetness to sucrose and is tolerated like sucrose. Also like sucrose, it is fully digested and provides the same caloric value of approximately 4 kcal/g. However, unlike sucrose, isomaltulose is low glycaemic and low insulinemic. The effect of isomaltulose is that the glucose enters the blood at a slow rate, avoiding high peaks and sudden drops in glucose levels and therefore insulin levels as well. This leads to a more balanced and prolonged energy supply in the form of glucose.

The term “sweet tasting protein” is to be understood as any purified or otherwise isolated protein that is capable of creating the olfactory sensation of sweet taste when exposed to taste receptors in human oral cavity. Currently there are six known sweet tasting proteins, all identified in tropical fruits. They include thaumatin, monellin, mabinlin, pentadin, brazzein, and curculin, and a seventh protein, miraculin, which is by itself not a sweet tasting protein, but rather a taste modifier.

### DETAILED DESCRIPTION OF THE INVENTION

The present invention concerns a composition for manufacturing a chocolate product, said composition comprising a non-sucrose non-glucose sweetener and at least 20% w/w fat, wherein
not more than 5%, or not more than 2%, or even not more than 1% w/w fermentable oligo-, di-, monosaccharide and polyols (FODMAPs) is present, and
wherein said non-sucrose non-glucosea sweetener is selected from the group comprising:
   e. mogroside enriched monk fruit extract (Siraitia grosvenorli);
   f. isomaltulose;
   g. sweet tasting protein;
   h. any combination of the above listed sweeteners.

The fat suitable for preparing a composition for a chocolate product can be selected from cocoa butter, chocolate butter, coconut oil, olive oil, soya oil, sunflower oil, rape seed oil, cotton seed oil, maize oil, safflower oil, ground nut oil, sesame oil, palm oil, butter fat, butter, butter cream, and derivatives thereof.

In an embodiment according to the previous embodiment of the present invention, the sweet tasting protein is selected from the group comprising thaumatin, monellin, mabinlin, pentadin, brazzein, curculin, miraculin, with preferably thaumatin

Because of the intensive sweetness, generally provided by the sweet tasting proteins in an advantageous embodiment, the sweet tasting protein content will advantageously be comprised between 0.1% and 10% w/w of the final composition.

For the same reasons, in an alternative embodiment the mogroside enriched monk fruit extract or, simply the monk fruit extract, will also advantageously be comprised between 0.1% and 10% w/w of the final composition.

As isomaltulose is characterised by a sweetness level comparable to that of sucrose the isomaltulose content will advantageously be comprised between 1% and 50% w/w of the final composition.

In a further highly advantageous embodiment, the composition of the invention further comprises fibre that is not a non-fermentable fibre or a slowly fermentable fibre such as lignin, and thus is almost not processed by intestinal flora and does not cause flatus formation and other gastrointestinal discomfort.

Although a universally accepted definition for dietary fibre does not exist, according to Directive 90/496/EEC this term includes edible carbohydrate chains with three or more monomeric units that are neither digested nor absorbed in the human small intestine and which are naturally occurring in the food as consumed, or which are obtained from raw food material by physical, enzymatical or chemical means with a beneficial physiological effect demonstrated by generally accepted scientific evidence, or which are synthetic carbohydrates with a beneficial physiological effect demonstrated by generally accepted scientific evidence. Dietary fibre in general consists of long chain polysaccharides and lignin (a cross-linked polymer of plant alcohols) that are not digested by human intestinal enzymes, but may undergo bacterial fermentation in the large intestine. The compounds considered as dietary fibre are generally split into two groups: water soluble and water insoluble. Much debate goes on over these classifications, especially in terms of physiological function. Gums, pectins, mucilages and certain hemicelluloses fall into the category of water soluble fibre. Cellulose, other hemicelluloses and lignin are considered as water insoluble and are beneficial in terms of regulating healthy peristalsis and contribution to stool bulk.

Fibre ingredients come from a number of sources and typically contain a mixture of water soluble and insoluble fibres. Most fibre ingredients, especially water insoluble forms, are derived from plants—grains like wheat, soy and oats; legumes; fruit; and even trees. Purified forms are available that can bring the level of a specific fibre component up to nearly 100%. These tend to have less colour, odour or flavour than their unpurified counterparts. Purified cellulose fibres derived from a variety of sources are particularly suitable for the application in the present invention, but other insoluble non-fermentable or very slowly fermentable fibre types may also be used.

In line with the above, according to one embodiment the composition according to the invention further comprises fibre source selected from any of the following:
a. insoluble non-fermentable fibre;
b. insoluble slowly fermentable fibre;
c. nuts;
d. any combination of the above listed fibre sources.

In particular embodiment according to proceeding embodiment the insoluble non-fermentable fibre is selected from the group comprising cellulose, sterculia, or methylcelullose; whereas the insoluble slowly fermentable fibre is lignin

In a particularly advantageous and desirable embodiment, the fibre is provided by natural sources such as fruits or nuts for as long as the potential FODMAP content within said natural nuts will not cause a FODMAP content of the final composition reach the maximum of 5%, or 2%, or even 1% w/w.

In a preferred embodiment, the fibre is provided by nuts selected from the group comprising whole nuts, chopped nuts, grounded nut powder, or a peeled or chopped counterpart thereof,

In advantageous embodiments, the nuts suitable for a composition according to the previous embodiment of the invention are selected from the group comprising almonds, cashews, peanuts, walnuts, hazelnuts, pecans, brazil nuts, macadamia nuts, pine nuts, or coconuts.

According to another aspect of the invention, a composition is provided for manufacturing a white or milk chocolate product, wherein a protein source is provided for mimicking milk protein fraction legally required in such chocolate products. As milk sugar, or lactose, is a FODMAP compound affecting a large part of human population, the protein source is to be understood as not comprising lactose or any other FODMAP compound in the amount that would cause the final composition to exceed the maximum of 1%, or 2%, or even 5% w/w FODMAP.

Thus, in a further embodiment of the present invention, a composition is provided further comprising a protein source comprising not more than 5%, or not more than 2%, or even not more than 1% w/w lactose and not more than 5%, or not more than 2%, or even not more than 1% w/w other FODMAP.

In a specific embodiment of the previous embodiment, the protein source is selected from the group comprising
a. milk protein extract or isolate;
b. casein/whey mixtures;
c. soy protein;
d. any combination of the above listed protein sources.

Lactose free chocolate offers little option other than isolated milk protein plus butterfat. Preferably the milk protein isolates will be composed of casein, whey or casein/whey mixtures and may be as sodium, potassium or calcium complexes. If the product is not to be sold as milk chocolate, then other protein sources may be considered, for example soy protein. The amount of milk protein and butterfat can be considered from two aspects; technical requirement and legal requirement. The legal situation can be summarised by the need for 14% milk solids of which 3.5% at least must be butterfat. Addition of milk protein and butterfat to give a total of 14% would cause large technical difficulties. Excessive protein makes the cocoa mass unworkable while excessive butterfat produces a very soft unmarketable chocolate. It can be argued that the spirit of the legislation requires that milk solids in a lactose free chocolate should be 14% minus the lactose content of 14% milk solids. This reduces the milk solids content to about 7.9%. Such a content of milk protein plus butterfat could be accommodated technically.

For lactose reduced chocolate, a wider range of ingredients is available, with ingredients with varying contents of milk protein, lactose and fat. As mentioned below, plant products such as soy protein powder or extract also provides a reasonable vegan alternative.

In further embodiments, the composition of the present invention may comprise any of the known in the art flavouring or aromatising agent or extract, such as vanilla, run, citrus etc.

In another aspect, the composition of the invention may further comprise a non-FODMAP active water regulating compound or an emulsifier. Possible emulsifiers include egg yolk, lecithin, polysorbate 80, polysorbates, soy lecithin, or combinations thereof.

The chocolate composition may further comprise one or more vitamins, minerals, electrolytes, trace elements, oils, health supplements, prebiotics, probiotics, kefir, phytonutrients, botanicals, nutraceuticals, herbs, amino acids, acidifiers, buffers, salts and combinations thereof.

The chocolate composition of the invention may further comprise energy related food ingredients selected from at least one of caffeine, taurine, guarana, B vitamins, ginseng, ginkgo biloba, L-carnitine, sugars, anti-oxidants or combinations thereof.

The chocolate composition may further comprise fruit, preferably a FODMAP reducing fruit, selected from banana, peach, apricot, lemon, raspberry, strawberry, wild berries, mango, passion fruit, guava, pomegranate, orange, blood orange, pear, lime mandarin, calamansi, pineapple, papaya, lychee, kiwi, coconut, rhubarb, pumpkin, plum, cantaloupe, green apple, fig, wild strawberry, redcurrant, cherry, blueberry, cranberry, blackcurrant, black cherry, watermelon, apple, carrot, grape, lemongrass, pink grapefruit, cassis, and combinations thereof, or bean, cocoa, nut blends and pastes, coffee, fruit purees, fruit juices, fruit pulps, vegetables, spices, caramel, liquor, liqueur, natural and artificial flavours, extracts, and combinations thereof.

Additionally, in an embodiment of the present invention, a chocolate product is provided which may be any product (tablet, bar, snack, praline, toffee, pastry, cake, etc.) comprising a chocolate composition and suitable for carrying a filling.

The invention includes formulations which meet the current regulations for chocolate and those which do not. The latter ones offer scope for use of ingredients not currently permitted in chocolate. For example, cocoa mass could be partially or completely replaced by cocoa flavouring, and cocoa butter could be replaced by other fats.

It should be noted that low FODMAP chocolate embodying this invention is suitable for people who are lactose intolerant and may also be reduced calorie chocolate due to the large elimination of the sugar content. To further illustrate the invention detailed, exemplifying formulations and their methods for manufacture are presented in the examples which follow. Manufacture may be performed in other ways, for example by use of an intermediate chocolate crumb. The method described is a variation of procedures familiar to those practised in chocolate manufacture.

### EXAMPLES

### Example 1: Dark Sugar Free Lactose Free Coconut Butter Based Chocolate

| | |
|---|---|
| 35-60% | coconut oil |
| 35-60% | cocoa powder or chocolate liquor |
| 0.01-15% | monk fruit mogroside extract or thaumatin |
| 2-20% | isomaltulose |

The ingredients were blended in a mixer to form a homogeneous mass. This mass was passed through a five roll refiner to reduce the particle size to 20-25 μm and then transferred to a conche for 6 hours at 40° C. The mass was then tempered, moulded into bars, cooled and demoulded.

### Example 2: Dark Sucrose Free Lactose Free Vanilla Flavoured Chocolate

| | |
|---|---|
| 35-60% | cocoa butter |
| 35-60% | cocoa powder or chocolate liquor |
| 1-10% | cellulose or methycelullose powder |
| 0.01-0.5% | salt |
| 0.01-5% | vanilla powder or extract |
| 0.01-15% | monk fruit mogroside extract or thaumatin |

The ingredients were blended in a mixer to form a homogeneous mass. This mass was passed through a five roll refiner to reduce the particle size to 20-25 μm and then transferred to a conche for 6 hours at 40° C. The mass was then tempered, moulded into bars, cooled and demoulded.

### Example 3: White Sucrose Free Lactose Free Vanilla Flavoured Chocolate

| | |
|---|---|
| 35-60% | cocoa butter |
| 0.01-5% | vanilla powder or extract |
| 0.01-0.5% | salt |
| 1-10% | finely ground almond flour or lactose free milk protein |
| | powder or casein powder or soymilk powder |
| 0.01-15% | monk fruit mogroside extract or thaumatin |
| 2-20% | isomaltulose |

The ingredients were blended in a mixer to form a homogeneous mass. This mass was passed through a five roll refiner to reduce the particle size to 20-25 μm and then transferred to a conche for 6 hours at 40° C. The mass was then tempered, moulded into bars, cooled and demoulded.

### Example 4: White Sucrose Free Lactose Free Chocolate (Fibre from Nuts)

| | |
|---|---|
| 35-60% | cacao butter |
| 35-60% | dry nuts (e.g. almonds, cashews, mix of both) |
| 0.01-5% | vanilla powder or extract |
| 0.01-15% | monk fruit mogroside extract or thaumatin |
| 2-20% | isomaltulose |

Cacao butter was melted and poured hot onto the raw dry nuts, then set aside for 1 hour for nuts to soak. The remaining ingredients were added and blended in a mixer to form a homogeneous mass. This mass was passed through a five roll refiner to reduce the particle size to 20-25 μm and then transferred to a conche for 6 hours at 40° C. The mass was then tempered, moulded into bars, cooled and demoulded.

### Example 5: White Sucrose Free Lactose Free Orange/Ginger Flavoured Chocolate

| | |
|---|---|
| 35-60% | cacao butter |
| 1-10% | finely ground almond flour or lactose free milk protein |
| | powder, sodium-caseinate powder or soymilk powder |
| 0.01-5% | vanilla powder or extract |
| 0.01-5% | orange extract |
| 0.01-5% | ground ginger |
| 0.01-0.5% | salt |
| 0.01-15% | monk fruit mogroside extract or thaumatin |
| 2-20% | isomaltulose |

The ingredients were blended in a mixer to form a homogeneous mass. This mass was passed through a five roll refiner to reduce the particle size to 20-25 μm and then transferred to a conche for 6 hours at 40° C. The mass was then tempered, moulded into bars, cooled and demoulded.

### Example 6: Sucrose Free Lactose Free Milk Chocolate

| | |
|---|---|
| 25-50% | cacao butter |
| 1-10% | coconut oil |
| 1-10% | cocoa powder or chocolate liquor |
| 1-10% | lactose free milk protein powder or casein powder or |
| | soymilk powder |
| 0.01-5% | vanilla powder or extract |
| 0.01-15% | monk fruit mogroside extract or thaumatin |

The ingredients were blended in a mixer to form a homogeneous mass. This mass was passed through a five roll refiner to reduce the particle size to 20-25 μm and then transferred to a conche for 6 hours at 40° C. The mass was then tempered, moulded into bars, cooled and demoulded.

### Example 7: Sucrose Free Lactose Free Dark Chocolate with Coconut and Nuts

| | |
|---|---|
| 35-60% | coconut oil |
| 5-40% | almond butter |
| 25-50% | cocoa powder or chocolate liquor |
| 0.01-5% | vanilla powder or extract |
| 0.01-5% | peppermint extract |
| 0.01-0.5% | salt |
| 2-10% | unsweetened shredded coconut |
| 2-10% | nuts, preferably peeled and chopped (walnuts, almonds, |
| | cashews, pecans) |
| 0.01-15% | monk fruit mogroside extract or thaumatin |

The ingredients (without shredded coconut and nuts) were blended in a mixer to form a homogeneous mass. This mass was passed through a five roll refiner to reduce the particle size to 20-25 μm and then transferred to a conche for 6 hours at 40° C., wherein the shredded coconut and nuts were added. The mass was then tempered, moulded into bars, cooled and demoulded.

### Example 8: Sucrose Free Lactose Free Vanilla Milk Chocolate

| | |
|---|---|
| 25-50% | cocoa powder or chocolate liquor |
| 25-50% | coconut oil |
| 0.01-5% | vanilla powder or extract |
| 0.01-0.5% | salt |
| 1-10% | Lactose free milk protein powder or casein powder or |
| | soymilk powder |
| 0.01-15% | monk fruit mogroside extract or thaumatin |
| 2-20% | isomaltulose |

The ingredients (without shredded coconut and nuts) were blended in a mixer to form a homogeneous mass. This mass was passed through a five roll refiner to reduce the particle size to 20-25 μm and then transferred to a conche for 6 hours at 40° C., wherein the shredded coconut and nuts were added. The mass was then tempered, moulded into bars, cooled and demoulded.

1. A composition for manufacturing a chocolate product, said composition comprising a non-sucrose non-glucose sweetener and at least 20% w/w fat, wherein
not more than 5%, or not more than 2%, or even not more than 1% w/w fermentable oligo-, di-, monosaccharides and polyols (FODMAPs) is present, and
wherein said non-sucrose non-glucose sweetener is selected from the group comprising:
a. Mogroside enriched monk fruit extract;
b. isomaltulose;
c. sweet tasting protein;
d. any combination of the above listed sweeteners.

2. The composition according to claim 1, wherein the sweet tasting protein is selected from the group consisting of: thaumatin, monellin, mabinlin, pentadin, brazzein, curculin, and miraculin.

3. The composition according to claim 1 further comprising fibre source selected from any of the following:
insoluble non-fermentable fibre;
insoluble slowly fermentable fibre;
nuts selected from the group consisting of: whole nuts, chopped nuts, grounded nut powder, and a peeled or chopped counterpart thereof; or
any combination of the above listed fibre sources.

4. The composition according to claim 3, wherein the insoluble non-fermentable fibre is selected from the group consisting of: cellulose, sterculia, and methylcelullose.

5. The composition according to claim 3, wherein the insoluble slowly fermentable fibre is lignin.

6. The composition according to claim 3, wherein the nuts are selected from the group consisting of: almonds, cashews, peanuts, walnuts, hazelnuts, pecans, brazil nuts, macadamia nuts, pine nuts, and coconuts.

7. The composition according to claim 1 further comprising protein source comprising not more than 5% lactose and not more than 5% other FODMAP.

8. The composition according to claim 7 wherein the protein source is selected from the group consisting of:
milk protein extract or isolate;
casein/whey mixtures;
soyprotein; and
any combination of the above listed protein sources.

9. The composition according to claim 1 further comprising a flavouring agent or extract.

10. The composition according to claim 1 further comprising a non-FODMAP active water regulating compound.

11. The composition according to claim 10 wherein the non-FODMAP active water regulating compound is lecithin.

12. The composition according to claim 1 wherein the mogroside enriched monk fruit extract content or the sweet tasting protein content is comprised between 0.1% and 10% w/w.

13. The composition according to claim 1 wherein the isomaltulose content is comprised between 1% and 50% w/w.

14. Use of the composition according to claim 1 for the manufacture of a chocolate product.

15. The use according to claim 14 wherein the chocolate product is selected from the group consisting of:
solid chocolate product such as bar or tablet;
filling for a chocolate product;
chocolate spread;
chocolate beverage; and
chocolate powder.

16. The composition according to claim 1, wherein the sweet tasting protein is thaumatin.

17. The composition according to claim 1 further comprising protein source comprising not more than 2% of lactose.

18. The composition according to claim 1 further comprising protein source comprising not more than 2% of other FODMAP.
